(19) United States
(12) Patent Application Publication
(10) Pub. No.: US 2016/0165945 A1
(43) Pub. Date: Jun. 16, 2016

(54) FOOD ADDITIVE

(71) Applicant: Van Hees, Inc., Cary, NC (US)

(72) Inventors: Deanna L. Hofing, Coatesville, IN (US); Martin Kempkes, Nettetal (DE)

(21) Appl. No.: 14/966,214

(22) Filed: Dec. 11, 2015

Related U.S. Application Data
(60) Provisional application No. 62/091,161, filed on Dec. 12, 2014.

(51) Int. Cl. A23L 3/3472; A23B 4/20

(52) U.S. Cl. CPC A23L 3/3472; A23B 4/20; A23V 2002/00

(57) ABSTRACT

The present invention relates to a food additive,, and more particularly to a food additive that provides antimicrobial properties, and extends shelf life while maintaining the flavor profile of the foodstuff. The food additive may include 10 to 50% by weight grapefruit and/or grapefruit seed extract, 20 to 50% by weight citrus fruit extract, and 5 to 20% by weight of one or more flavorants selected from the group consisting of cacao, pomegranate, hops, curry, coriander, nutmeg, lovage, fenugreek, olive, onion, garlic, oregano, cinnamon, rosemary, thyme, tarragon, lemon grass, cumin, and anise.

### CROSS REFERENCE TO RELATED APPLICATIONS

This application claims priority to U.S. Provisional Application Ser. No. 62/091,161, filed Dec. 12, 2014, the disclosure of which is incorporated herein by reference in its entirety.

### FIELD AND BACKGROUND OF THE INVENTION

The present invention relates to a food additive, and more particularly to a food additive that provides antimicrobial properties, and extends shelf life while maintaining the flavor profile of the foodstuff.

During the processing, preparation, packaging, and use of a foodstuff, the foodstuff is susceptible to microorganisms which may make the foodstuff unsuitable for consumption. Exemplary foodstuffs include meat, poultry, fish and shellfish, cheese, fruits and vegetables, and prepared foods. Being unsuitable for consumption, ranges from the perception of lower quality to food-borne illnesses and possibly death. Exemplary problematic microorganisms include Listeria monocytogenes, Salmonella, E. Coli, staphylococcus aureas, and clostridium perfringens.

### SUMMARY OF THE INVENTION

To this end, it is desirable to provide a food additive that when added to a foodstuff has antimicrobial properties and also extends shelf life, and has a perception of either maintaining or improving the flavor of the foodstuff. Additionally, the food additive includes ingredients that are GRAS grade materials.

The present invention provides a composition comprising 10 to 50% by weight grapefruit and/or grapefruit seed extract, 20 to 50% by weight citrus fruit extract(s), and 5 to 20% by weight of one or more of an extract selected from the group consisting of flavorants.

In another embodiment, the present invention provides a composition comprising 10 to 90% by weight grapefruit and/or grapefruit seed extract, 10 to 90% by weight lemon extract, and 0 to 20% by weight of one or more flavorants.

### BRIEF DESCRIPTION OF THE DRAWINGS

FIG. 1 is a Log CFU/g versus time graph for Aerobic Plate Count (APC) for the Control and Examples 1A and 1B.

FIG. 2 is a Log CFU/g versus time graph for E. Coli Plate Count for the Control and Examples 1A and 1B.

FIG. 3 is a Log CFU/g versus time for Coliforms Plate Count for the Control and Examples 1A and 1B.

FIG. 4 is a Log CFU/g versus time graph for Lactic Acid Bacteria Plate Count (Total Lactics) for the Control and Examples 1A and 1B.

FIG. 5 is a Log CFU/g versus time graph for Yeast Plate Count for the Control and Examples 1A and 1B.

FIG. 6 is a Log CFU/g versus time graph for Mold Plate Count for the Control and Examples 1A and 1B.

FIG. 7 is a Log CFU/g versus time graph for Listeria Plate Count for the Control and Examples 1A and 1B.

FIG. 8 is a Log CFU/g versus time graph for Aerobic Plate Count (APC) for the Control and Examples 2A and 2B.

FIG. 9 is a Log CFU/g versus time graph for E. Coli Plate Count for the Control and Examples 2A and 2B.

FIG. 10 is a Log CFU/g versus time graph for Coliforms Plate Count for the Control and Examples 2A and 2B.

FIG. 11 is a Log CFU/g versus time graph for Lactic Acid Bacteria Plate Count (Total Lactics) for the Control and Examples 2A and 2B.

FIG. 12 is a Log CFU/g versus time graph for Yeast Plate Count for the Control and Examples 2A and 2B.

FIG. 13 is a Log CFU/g versus time graph for Mold Plate Count for the Control and Examples 2A and 2B.

FIG. 14 is a Log CFU/g versus time graph for Listeria Plate Count for the Control and Examples 2A and 2B.

FIG. 15 is a Log CFU/g versus time graph for Aerobic Plate Count (APC) for the Control and Examples 3A and 3B.

FIG. 16 is a Log CFU/g versus time graph for E. Coli Plate Count for the Control and Examples 3A and 3B.

FIG. 17 is a Log CFU/g versus time graph for Coliforms Plate Count for the Control and Examples 3A and 3B.

FIG. 18 is a Log CFU/g versus time graph for Lactic Acid Bacteria Plate Count (Total Lactics) for the Control and Examples 3A and 3B.

FIG. 19 is a Log CFU/g versus time graph for Yeast Plate Count for the Control and Examples 3A and 3B.

FIG. 20 is a Log CFU/g versus time graph for Mold Plate Count for the Control and Examples 3A and 3B.

FIG. 21 is a Log CFU/g versus time graph for Listeria Plate Count for the Control and Examples 3A and 3B.

FIG. 22 is a Log CFU/g versus time graph for Aerobic Plate Count (APC) for the Control and Examples 4A and 4B.

FIG. 23 is a Log CFU/g versus time graph for Coliforms Plate Count for the Control and Examples 4A and 4B.

FIG. 24 is a Log CFU/g versus time graph for Lactic Acid Bacteria Plate Count (Total Lactics) for the Control and Examples 4A and 4B.

FIG. 25 is a Log CFU/g versus time graph for Yeast Plate Count for the Control and Examples 4A and 4B.

FIG. 26 is a Log CFU/g versus time graph for Mold Plate Count for the Control and Examples 4A and 4B.

FIG. 27 is a Log CFU/g versus time graph for Aerobic Plate Count (APC) for the Control and Examples 5A and 5B.

FIG. 28 is a Log CFU/g versus time graph for Aerobic Plate Count (APC) for the Control and Examples 6A and 6B.

FIG. 29 is a Log CFU/g versus time graph for Lactic Acid Bacteria Plate Count (Total Lactics) for the Control and Examples 7A and 7B.

FIG. 30 is a Log CFU/g versus time graph for Lactic Acid Bacteria Plate Count (Total Lactics) for the Control and Examples 8A and 8B.

FIG. 31 is a Log CFU/g versus time graph for Lactic Acid Bacteria Plate Count (Total Lactics) for the Control and Examples 9A and 9B.

FIG. 32 is a Log CFU/g versus time graph for Lactic Acid Bacteria Plate Count (Total Lactics) for the Control, Vinegar Powder and Examples 10A and 10B.

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items.

The term “about” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

As used herein, the terms “comprise,” “comprises,” “comprising,” “include,” “includes” and “including” specify the presence of stated features, integers, steps, operations, elements, and/or components, but do not preclude the presence or addition of one or more other features, integers, steps, operations, elements, components, and/or groups thereof.

As used herein, the term “consists essentially of” (and grammatical variants thereof), as applied to the compositions and methods of the present invention, means that the compositions/methods may contain additional components so long as the additional components do not materially alter the composition/method. The term “materially alter,” as applied to a composition/method, refers to an increase or decrease in the effectiveness of the composition/method of at least about 20% or more.

All patents, patent applications and publications referred to herein are incorporated by reference in their entirety. In case of a conflict in terminology, the present specification is controlling.

The present invention provides a food additive for application to a foodstuff to limit microbial activity, import antioxidant properties, and improve shelf life without an adverse affect on the flavor of the foodstuff (i.e., the organoleptic properties of the foodstuff are maintained or improved). The term “foodstuff” is intended to mean a substance which is suitable for human or animal consumption, and includes dairy products (e.g., cheese), animal foods (e.g., dog and cat food), snack foods (e.g., pretzels, chips, crackers), sauces and gravies, soups, casseroles, juices (e.g., fruits and vegetables), prepared meat and meat spreads, cereals, margarine, salad dressings, condiments (e.g., ketchup and mustard), meat, fish and shellfish, and poultry.

A composition for providing antimicrobial properties to food is provided. An exemplary composition is:
a) 10 to 50% by weight grapefruit and/or grapefruit seed extract;
b) 20 to 50% by weight citrus fruit extract(s); and
c) 5 to 20% by weight of one or more of a flavorant.

In another embodiment, the present invention provides a composition comprising:
a) 10 to 90% by weight grapefruit and/or grapefruit seed extract;
b) 10 to 90% by weight lemon extract; and
c) 0 to 20% by weight of one or more flavorants.

Exemplary citric extracts may include orange extract, lime extract, and lemon extract, alone or in combination. The extract may be in the form of a liquid or solid (powder).

Exemplary flavorants include selected from the group consisting of cacao, pomegranate, hops, curry, coriander, nutmeg, lovage, fenugreek, onion, garlic, oregano, olive, cinnamon, rosemary, thyme, tarragon, lemon grass, chili powder, cumin, and anise.

The composition may include a carrier such as a monosaccharide (e.g., dextrose), a polysaccharide (e.g., maltodextrin), starches, rice flour, and salt, commonly used as food additives.

The composition may include other additives such as dust control additives (e.g., vegetable oil), emulsifiers, preservatives, antioxidants, colorants, antimicrobials, flavorings, and anti-caking agent (e.g., silicon dioxide). Preferably these additives are on the GRAS list issued by the FDA.

The food additive is added or applied to the foodstuff in a form and method known to those skilled in the art. For example, the additive can be in the form of a powder, granular blend, or a liquid, and can be applied to or mixed with the foodstuff using marination, kneading, blending, tumbling, spraying, massaging, injecting, mixing and the like.

The present invention will be further illustrated by the following non-limiting examples.

### EXAMPLES 1 to 6A/6B

The affect of the compositions of one embodiment of the invention on shelf life and antimicrobial properties were tested on turkey roll, hot dogs, ham, chicken breast, ground pork, and ground beef. The composition used as an additive for the Examples 1 to 6A/6B (“Composition A”) comprises:

### EXAMPLES 1A and 1B (TURKEY ROLL)

| Ingredient | % in Composition A |
|---|---|
| Grapefruit Seed Extract | 23.2 |
| Dextrose (Natural) | 18.0 |
| Maltodextrin | 16.0 |
| Orange Extract | 12.0 |
| Lime Extract | 10.2 |
| Lemon Extract | 8.40 |
| Cacao Extract | 7.20 |
| Pomegranate Extract | 4.20 |
| Silicon Dioxide (anti-caking | .80 |
| agent) | |

The above was folded into a brine solution to provide a 0.75% and 1.0 percent by weight solution of the invention as follows:

| | | Example 1A | Example 1B |
|---|---|---|---|
| Component | Control | (0.75%) | (1.0%) |
| Water and Ice | 77.60 | 74.97 | 74.10 |
| Salt (granular) | 5.60 | 5.60 | 5.60 |
| Dextrose | 7.00 | 7.00 | 7.00 |
| GPI Carrageenan | 1.40 | 1.40 | 1.40 |
| Modified Food | 7.00 | 7.00 | 7.00 |
| Starch | | | |
| Sodium Phosphate | 1.40 | 1.40 | 1.40 |
| Composition A | — | 2.63 | 3.50 |

A turkey roll was prepared by grinding 90% breast meat through a kidney plate and 10% breast meat through a ⅛ inch plate. This was added to the Control (no additive) or 0.75/1.0% (Example 1A and 1B) at a 140% by weight basis. The turkey roll was put into plastic casings overnight and cooked.

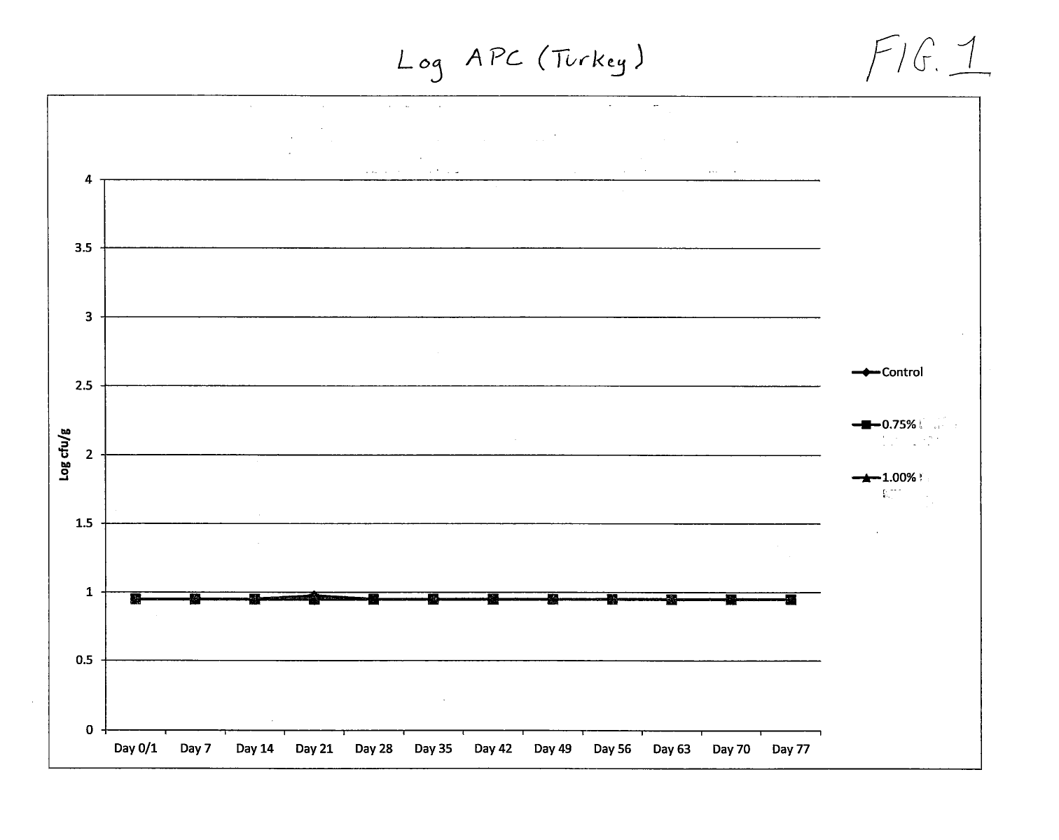

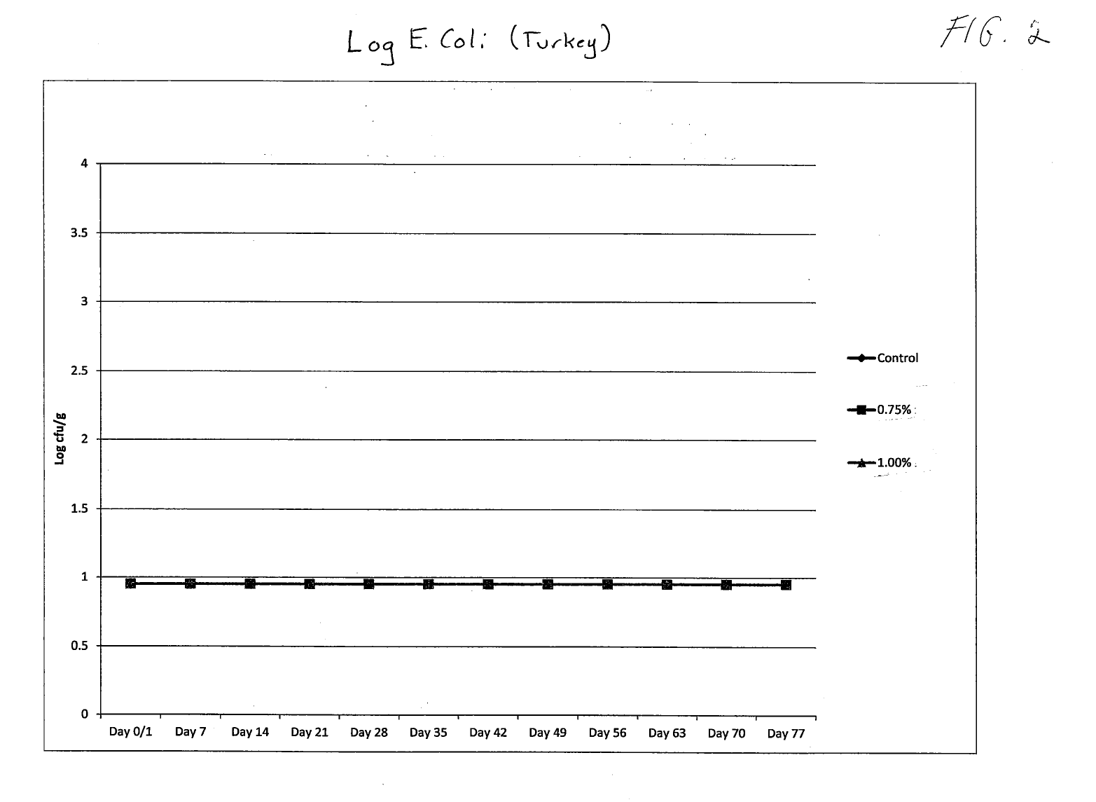

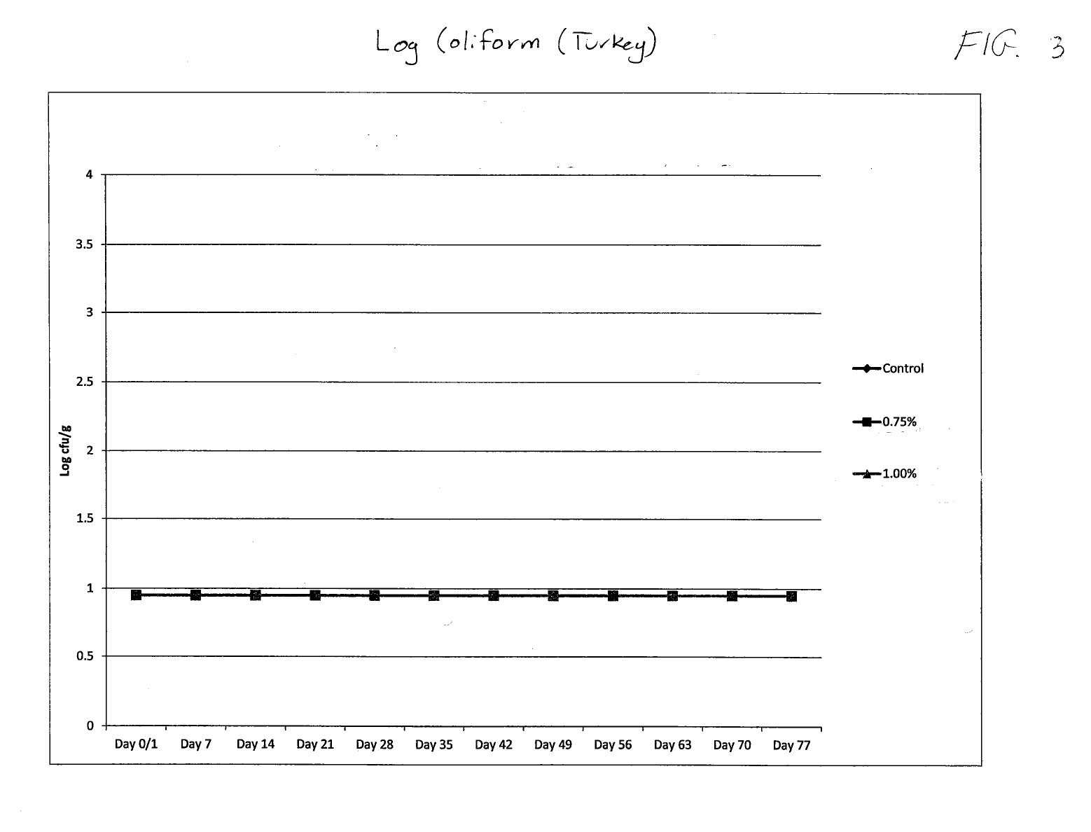

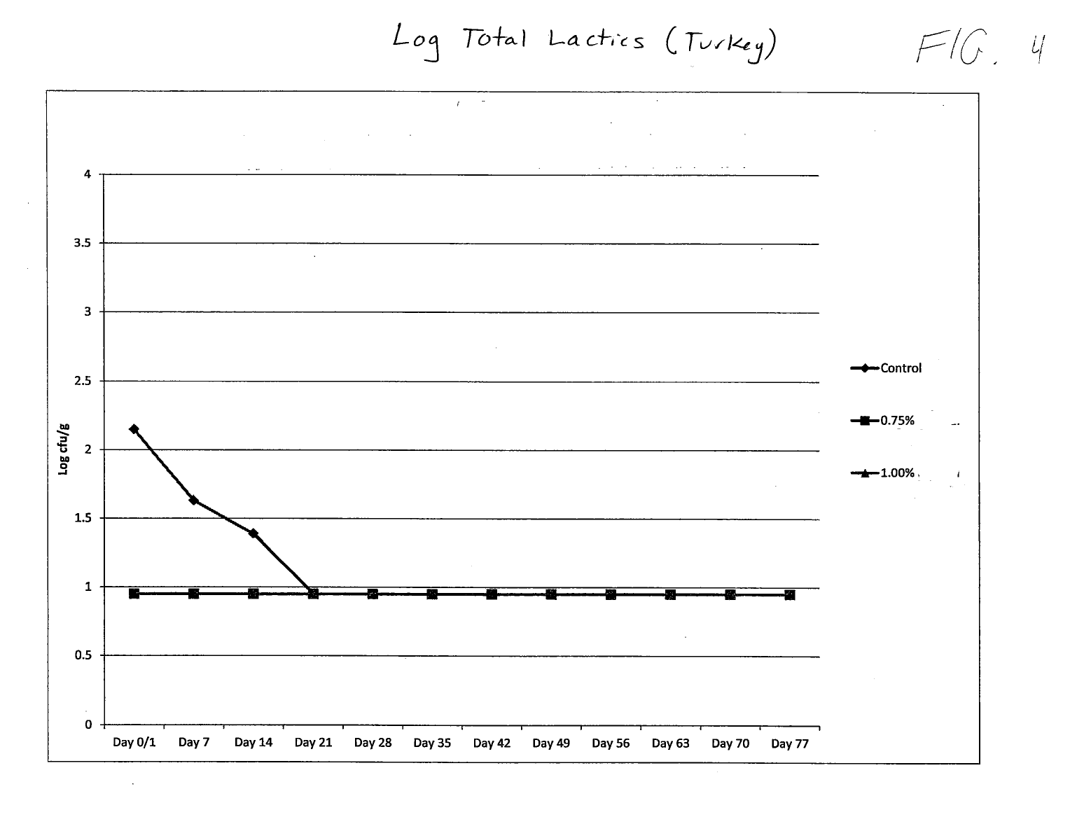

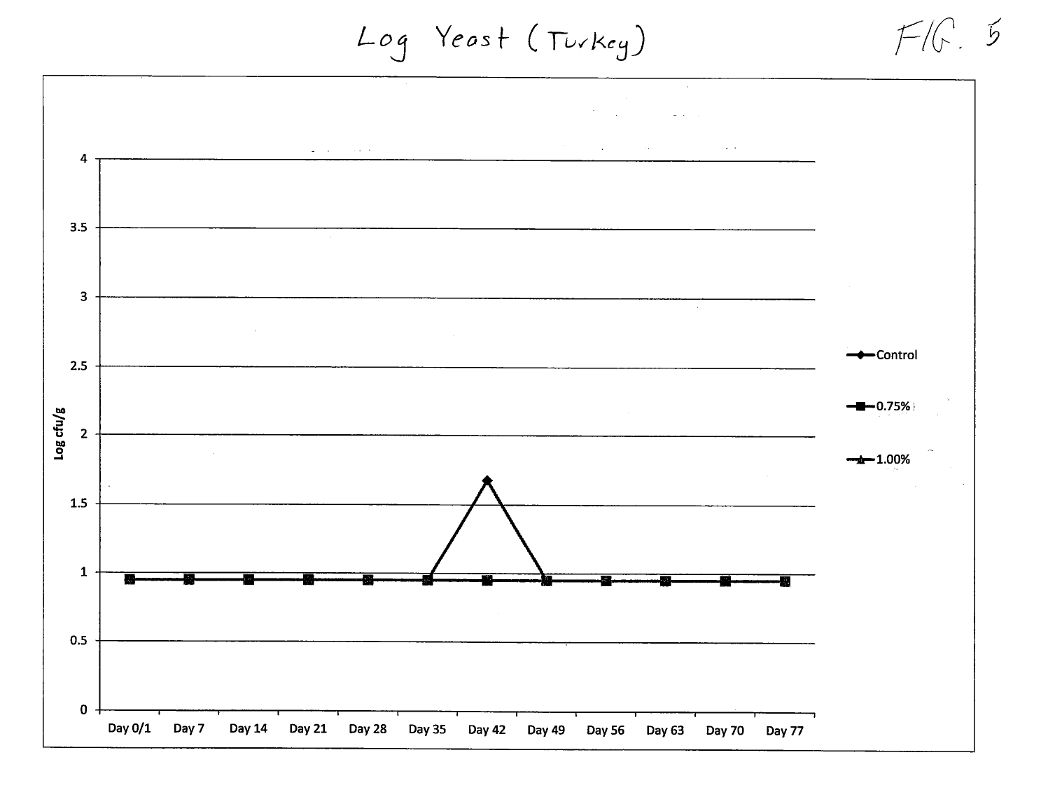

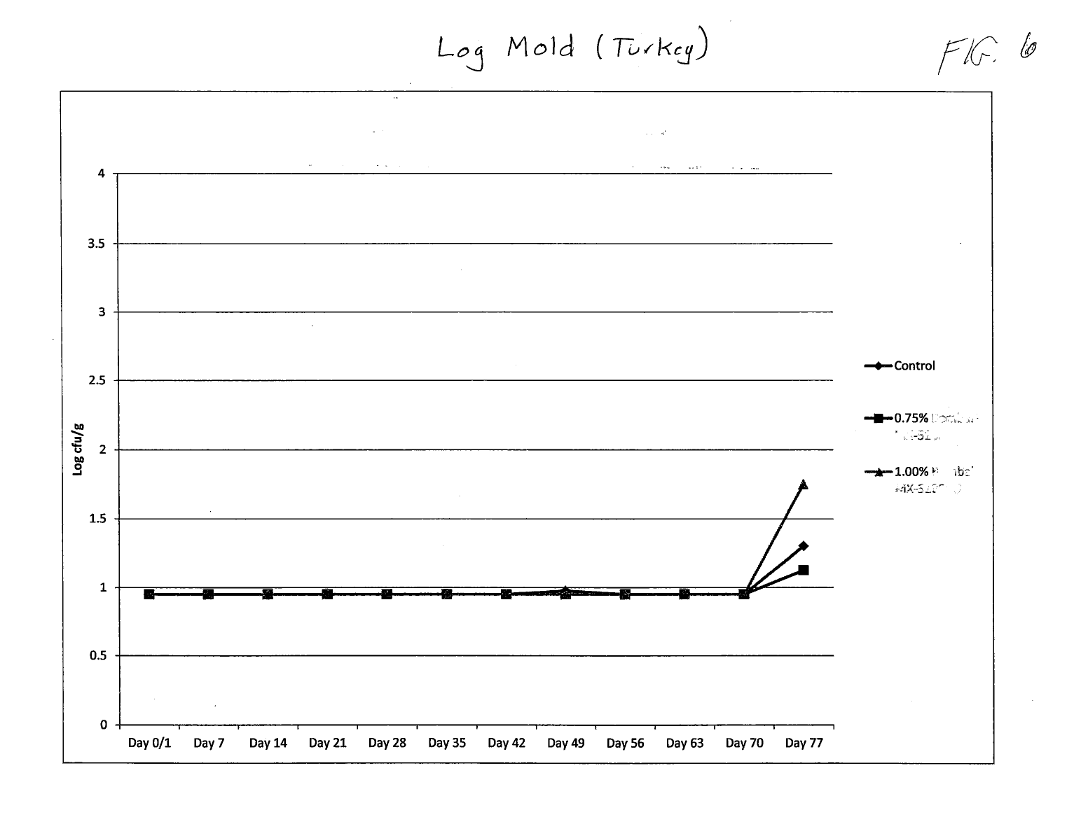

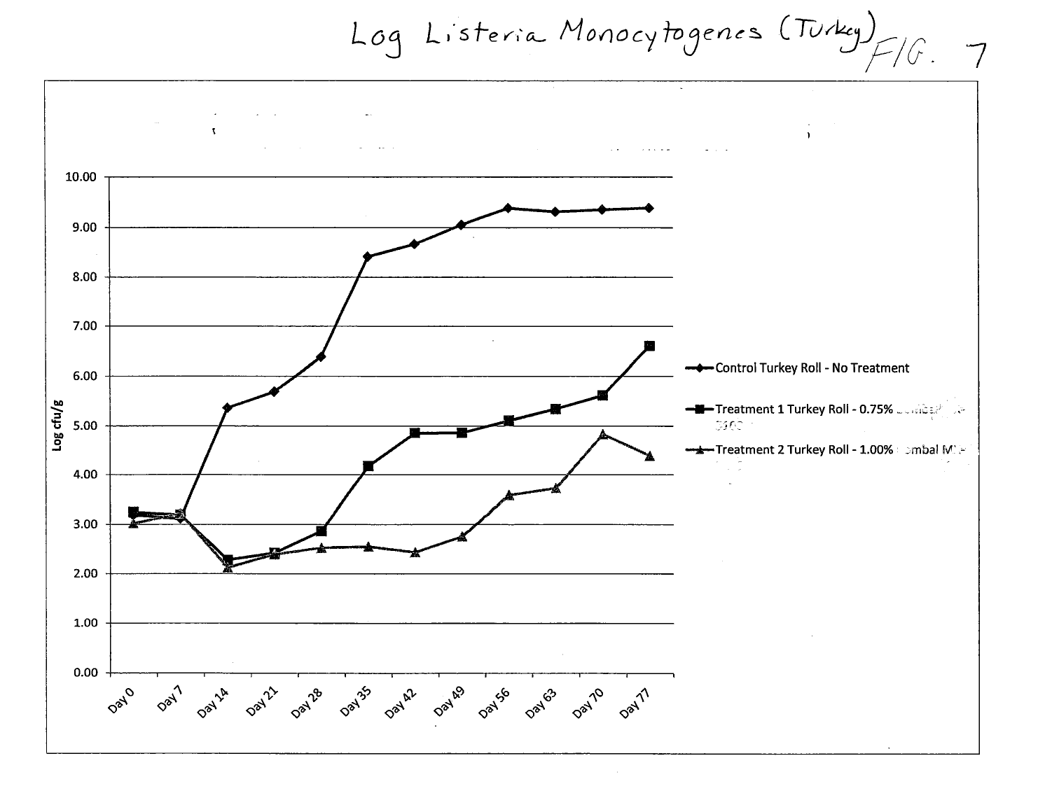

The turkey roll was incubated at 40° F. and monitored for aerobic plate count, E. coli, coliforms, lactic acid bacteria, yeast, mold, and listeria. The positive results for the invention are shown in FIGS. 1-7.

### EXAMPLES 2A and 2B (HOT DOGS)

The above was repeated with hot dogs prepared by grinding lean pork and beef trim 50/50 mixture together with sea salt, celery powder, water, and the Control or 0.75/1.0% solutions of the invention.

| | | Example 2A | Example 2B |
|---|---|---|---|
| Component | Control | (0.75%) | (1.0%) |
| Pork Trimmings | 49.19 | 48.93 | 48.78 |
| Beef Trim 50's | 21.23 | 21.12 | 21.06 |
| Water | 23.58 | 23.45 | 23.38 |
| Sea Salt | 2.60 | 2.58 | 2.58 |
| Cane Sugar | 2.04 | 2.03 | 2.03 |
| Onion Powder | 0.03 | 0.03 | 0.03 |
| Ground Mustard | 1.06 | 1.05 | 1.05 |
| Flavoring 032414JL | 0.03 | 0.03 | 0.03 |
| Celery | 0.25 | 0.25 | 0.25 |
| Composition | — | 0.53 | 0.70 |
| Sodium Carbonate | — | — | 0.125 |

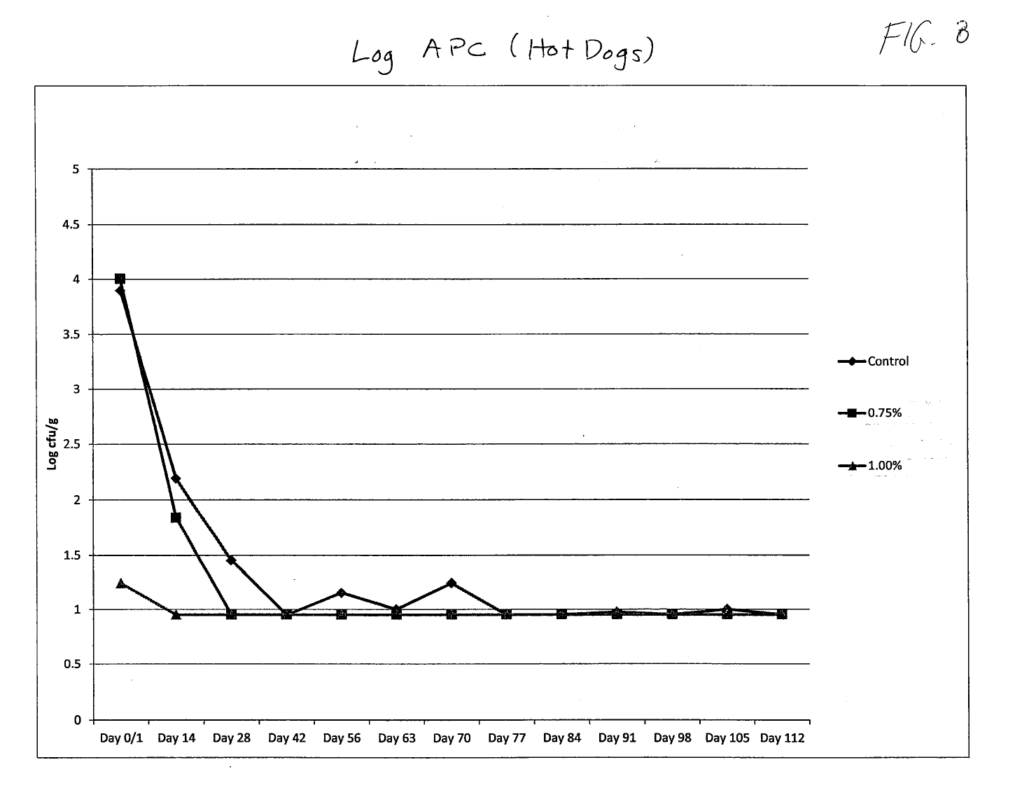

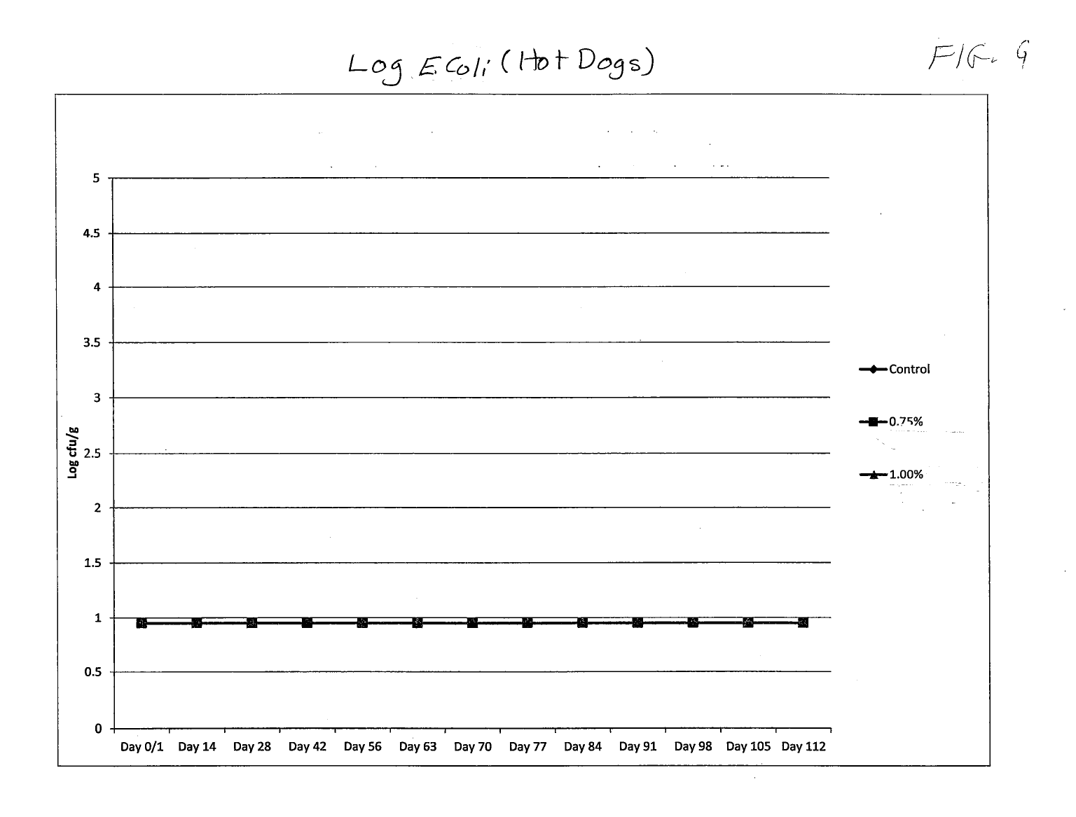

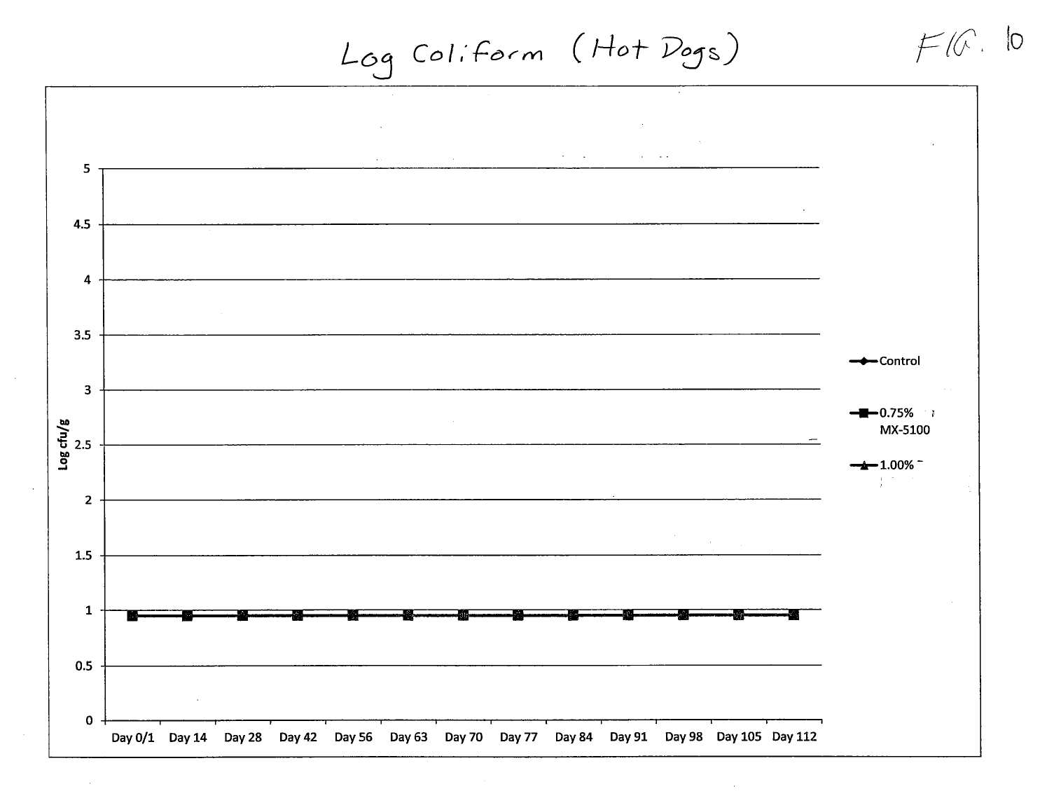

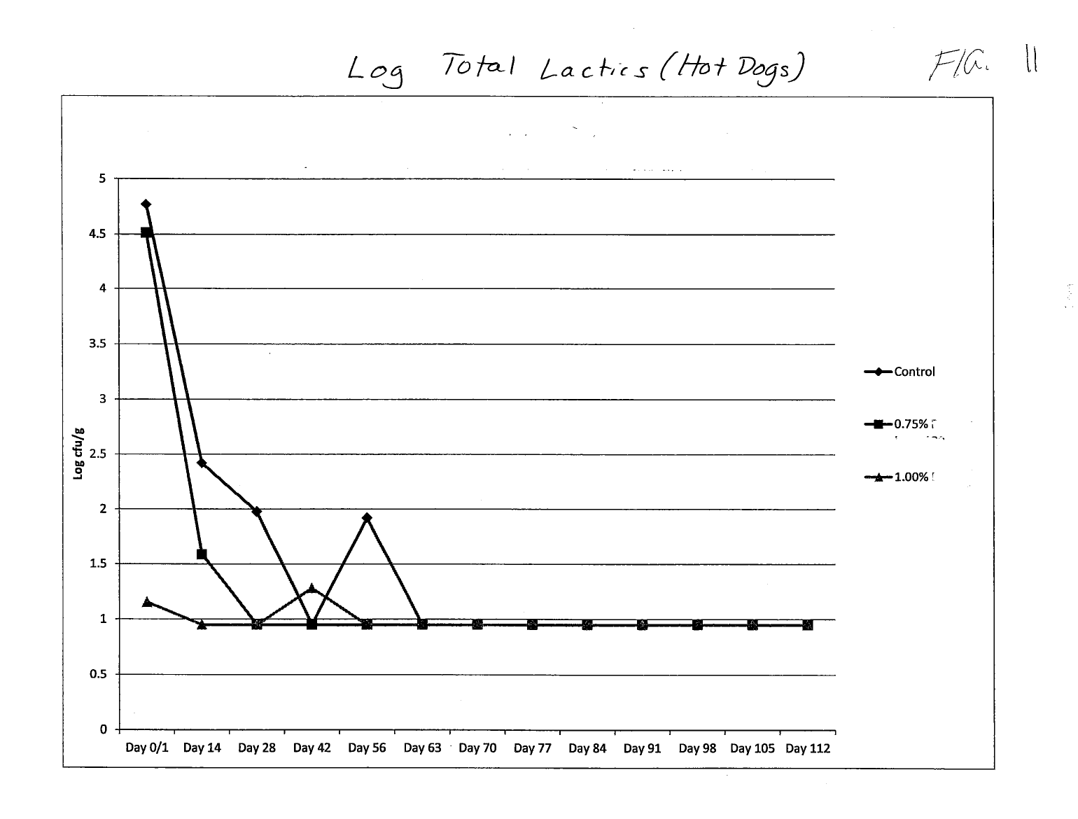

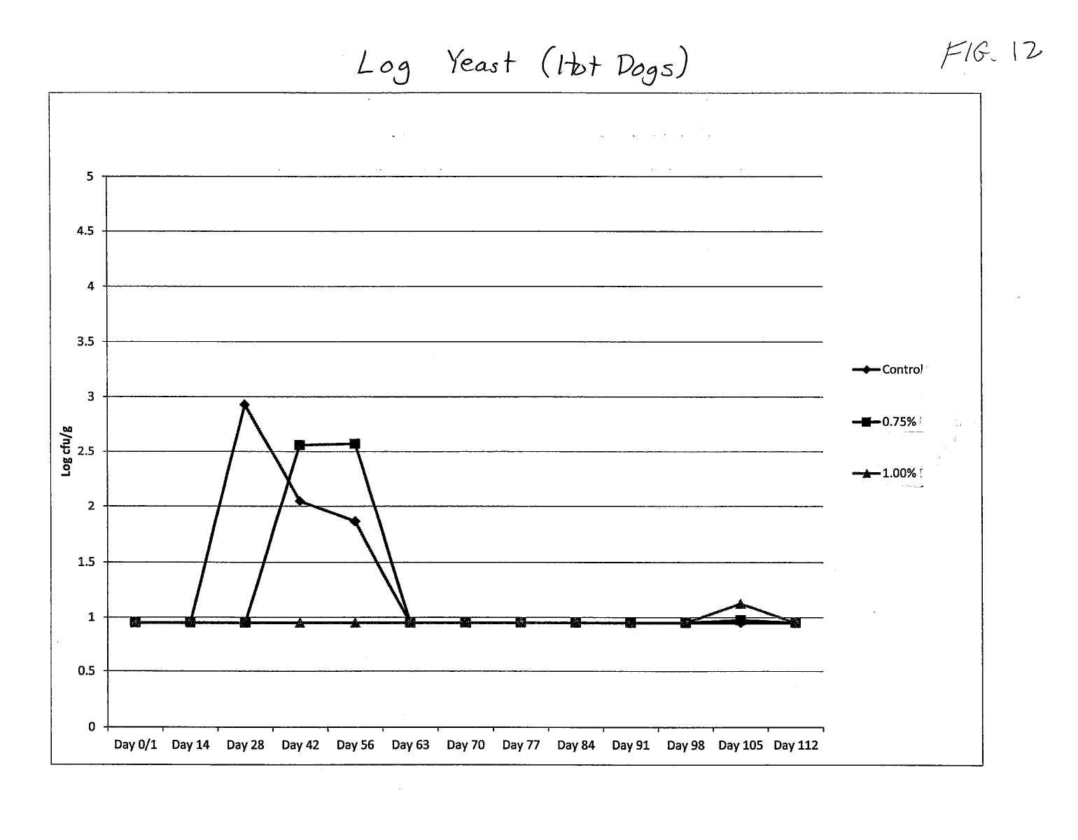

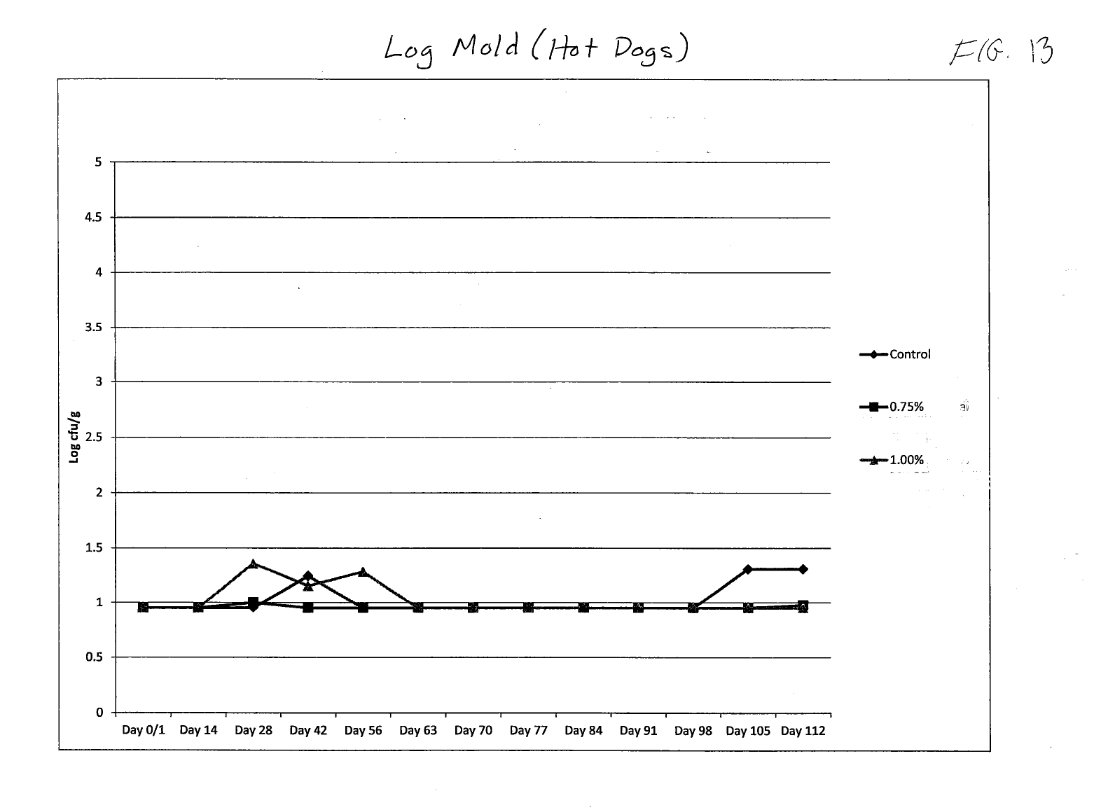

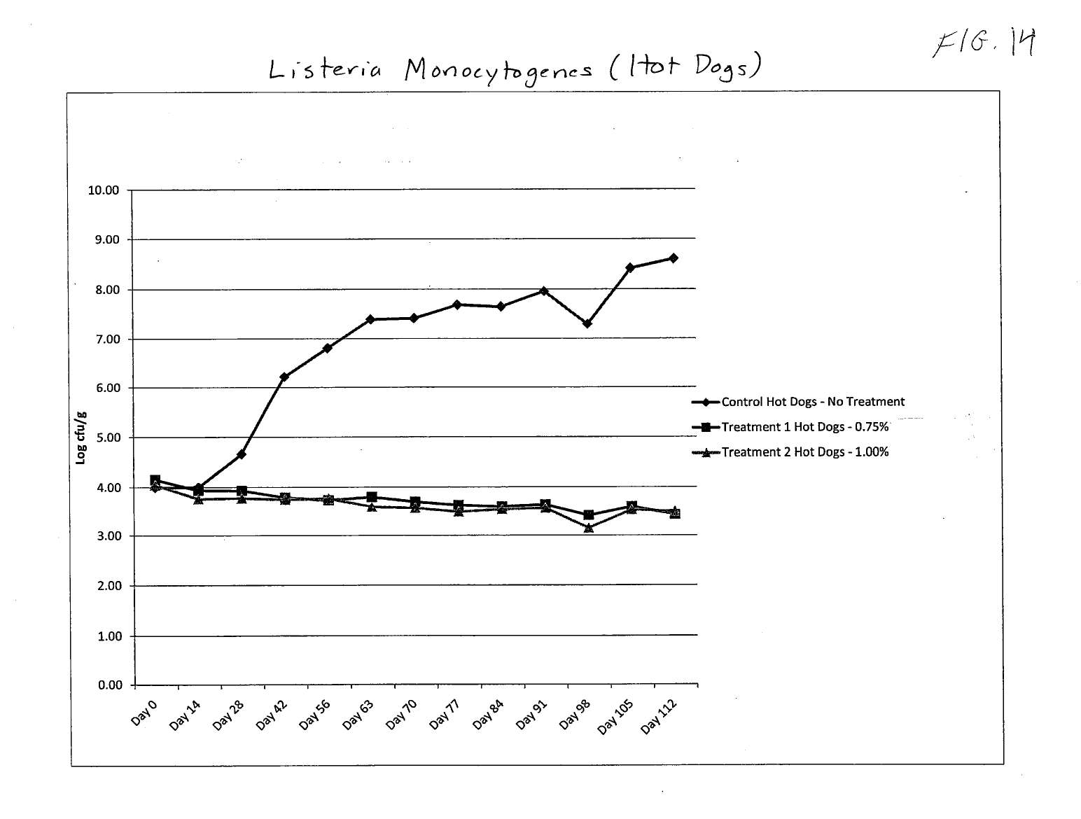

Aerobic plate count, E. coli, coliforms, lactic acid bacteria, yeast, mold, and listeria were monitored and the positive results for the invention are shown in FIGS. 8-14.

### EXAMPLES 3A and 3B (HAM)

A ham was obtained from Seaboard Foods and brined with the following composition.

| | | Example 3A | Example 3B |
|---|---|---|---|
| Component | Control | (0.75%) | (1.0%) |
| Water and Ice | 78.7000 | 75.2.84 | 74.0934 |
| Sea Salt | 10.3.25 | 10.2596 | 10.2459 |
| Cane Sugar | 9.4875 | 9.4875 | 9.4262 |
| Celery | 1.5000 | 1.4923 | 1.4903 |
| Composition | — | 3.0779 | 4.0984 |
| Sodium Carbonate | — | 0.5130 | 0.6458 |

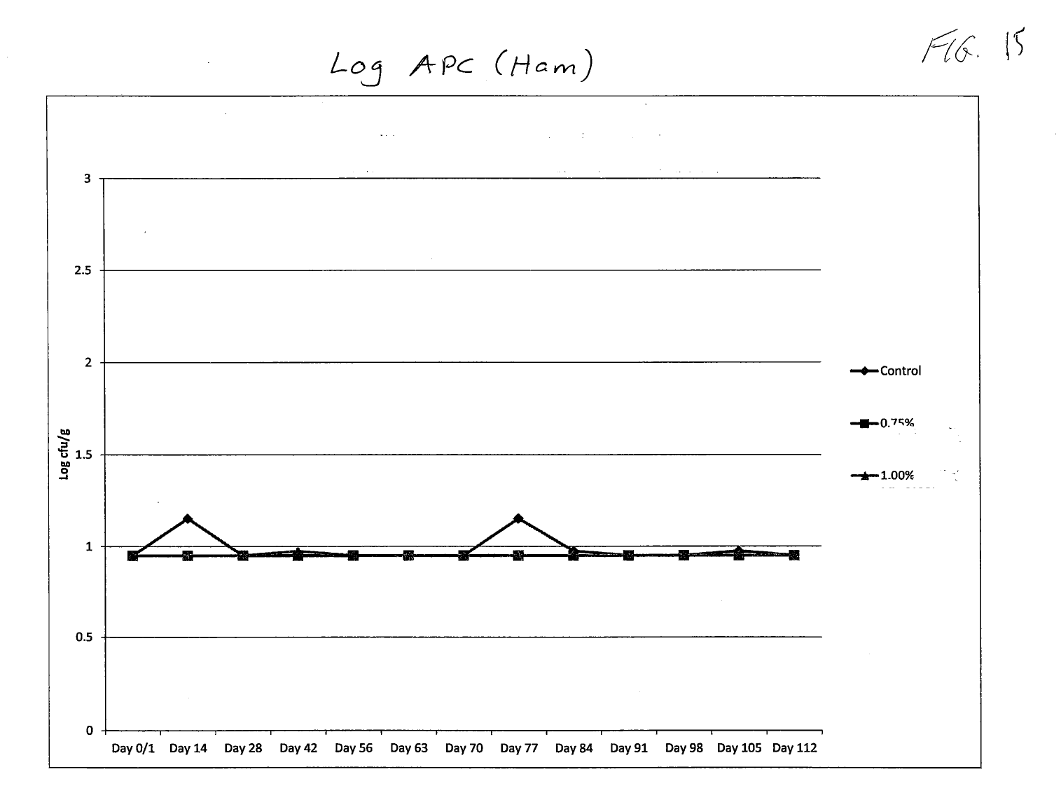

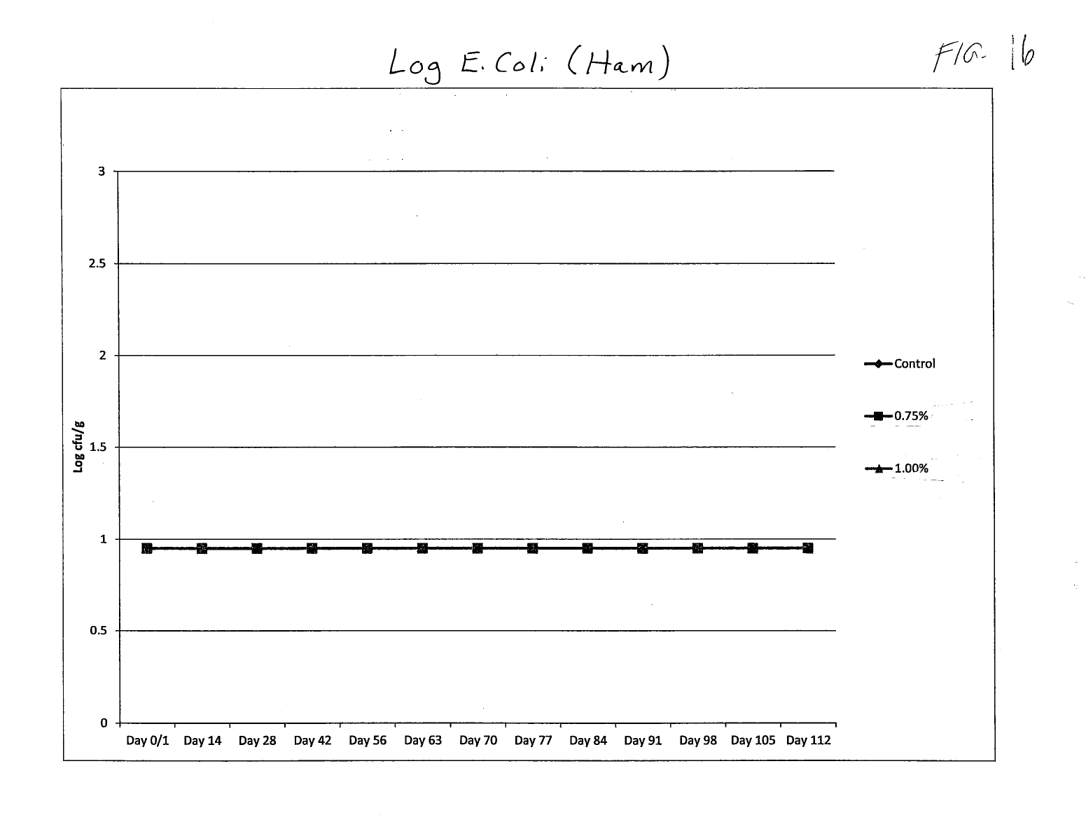

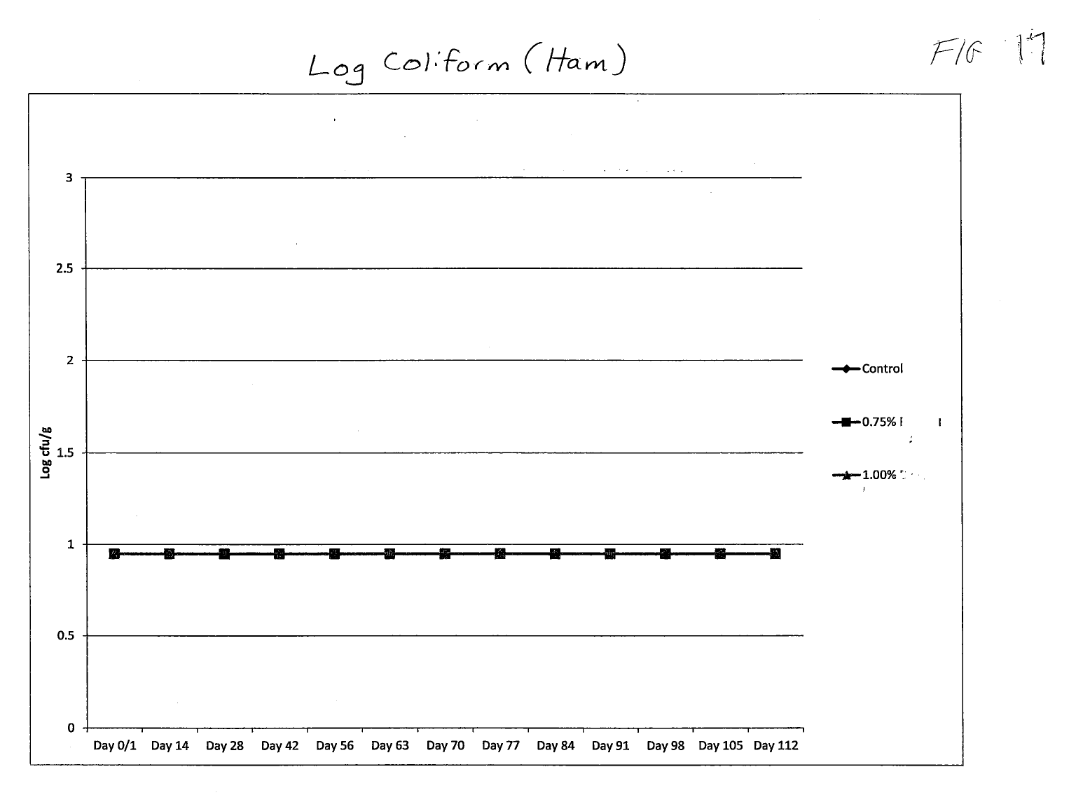

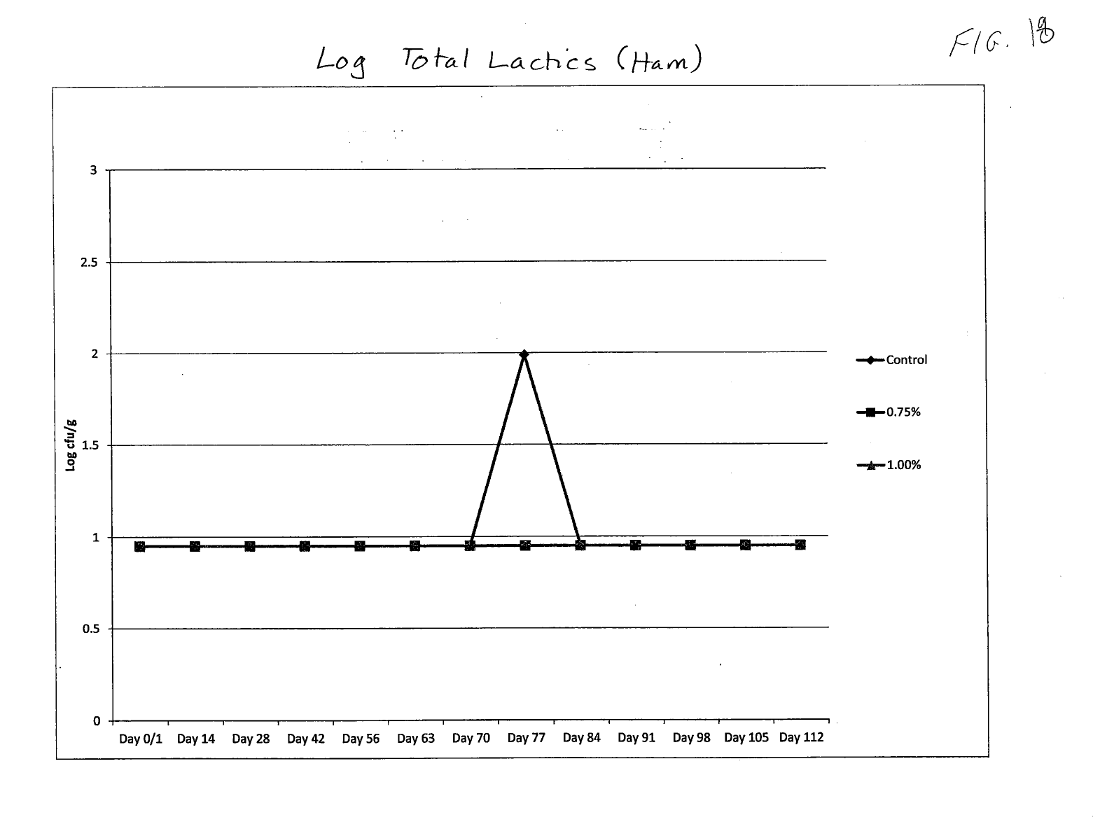

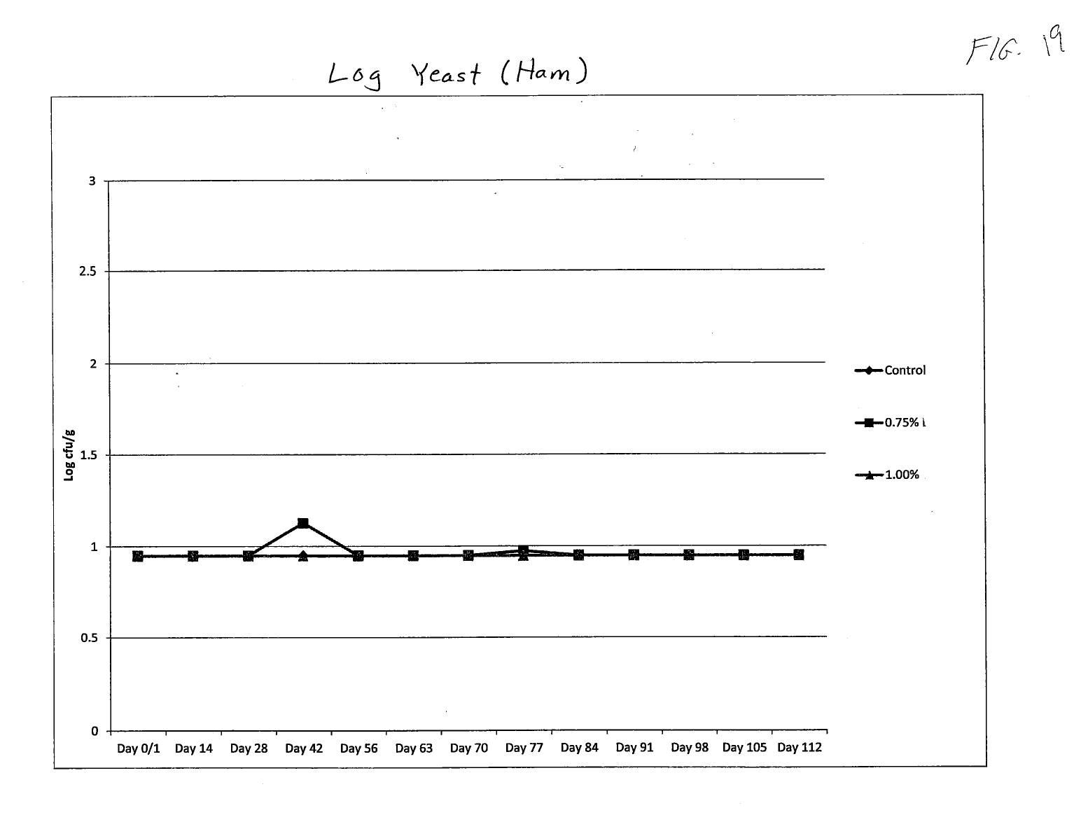

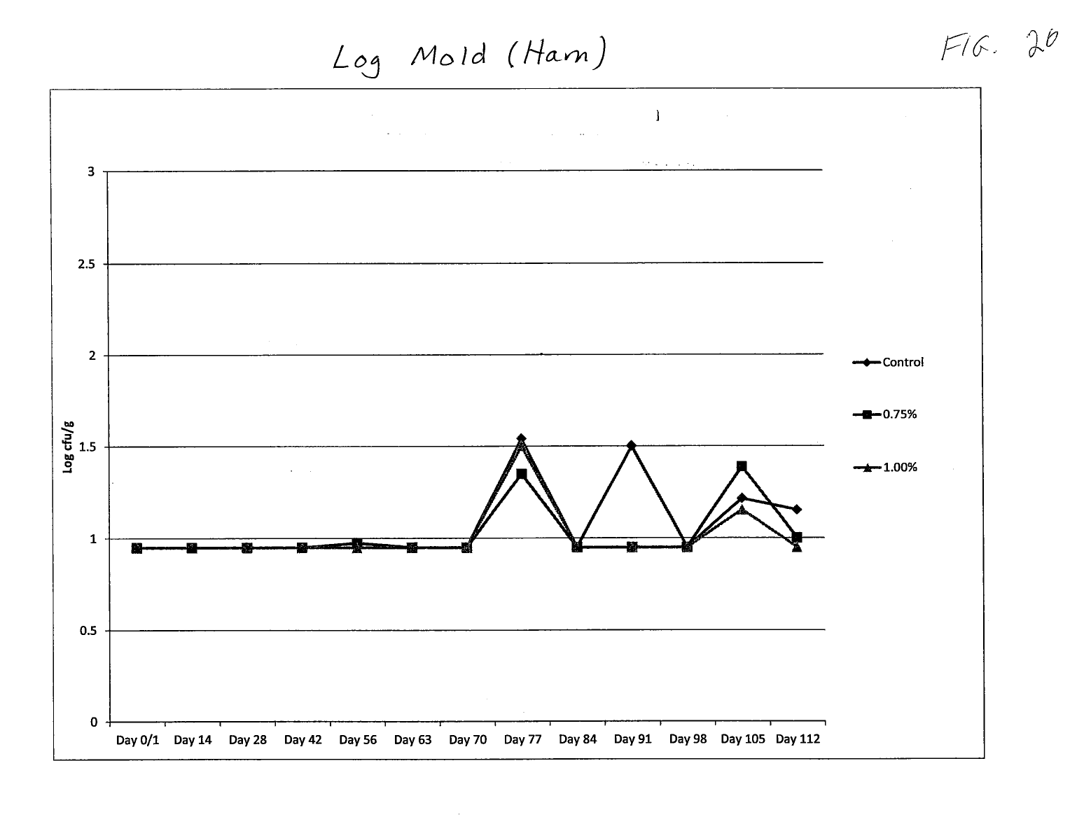

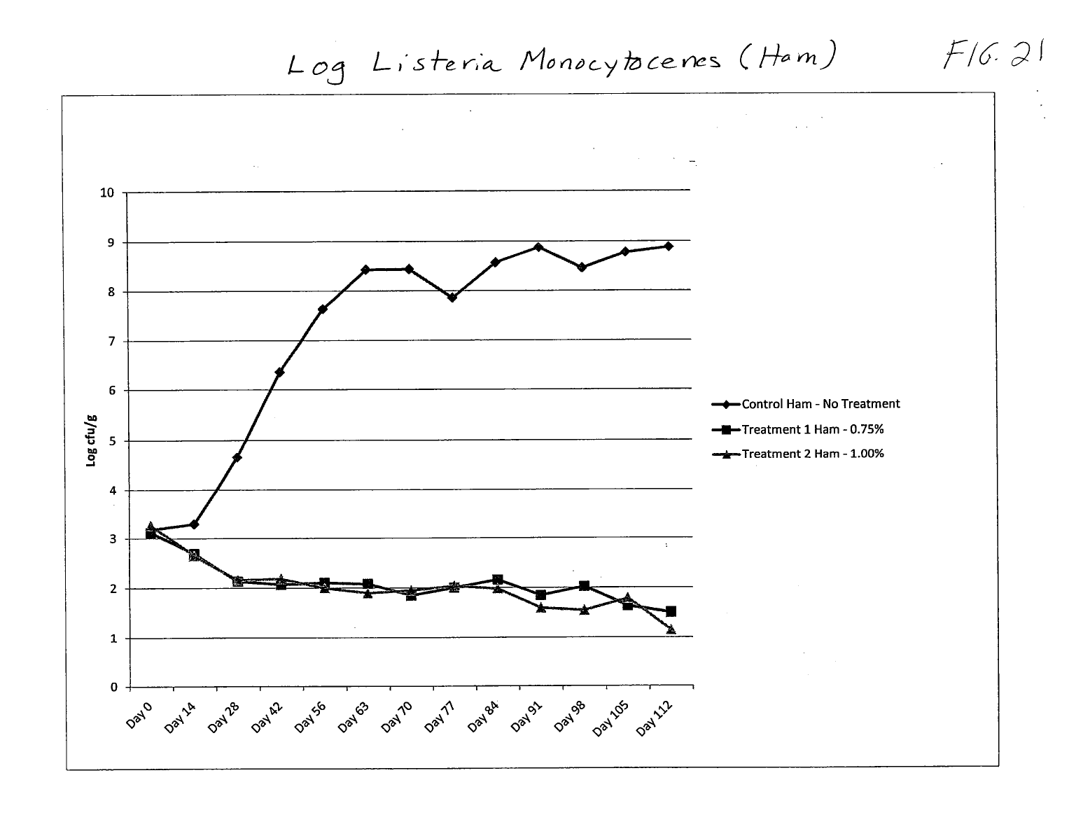

Aerobic plate count, E. coli, coliforms, lactic acid bacteria, yeast, mold, and listeria were monitored and the positive results for the invention are shown in FIGS. 15-21.

### EXAMPLES 4A and 4B (CHICKEN BREASTS)

Chicken breasts from Pilgrims Pride was obtained and brined in the following compositions:

| | | Example 4A | Example 4B |
|---|---|---|---|
| Component | Control | (0.75%) | (1.0%) |
| Water and Ice | 90.03 | 88.50 | 86.19 |
| Sodium phosphate | 2.30 | 2.30 | 2.30 |
| Salt | 7.67 | 7.67 | 7.67 |
| Composition | — | | |

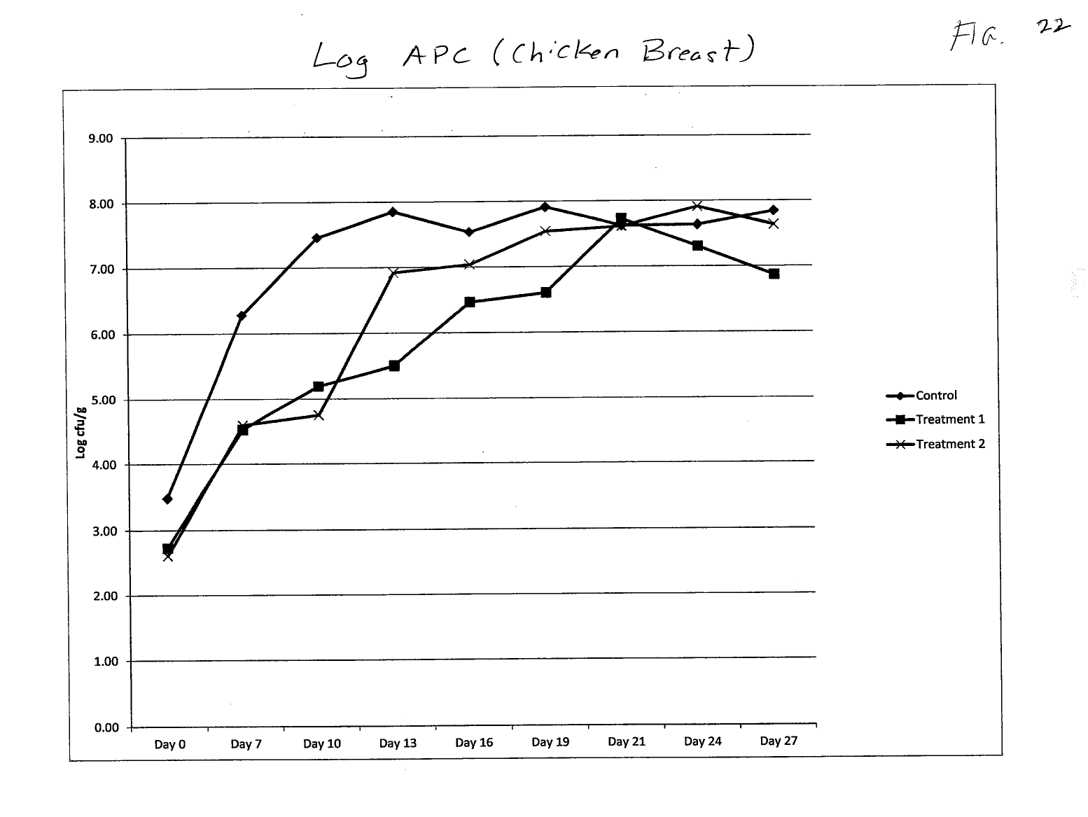

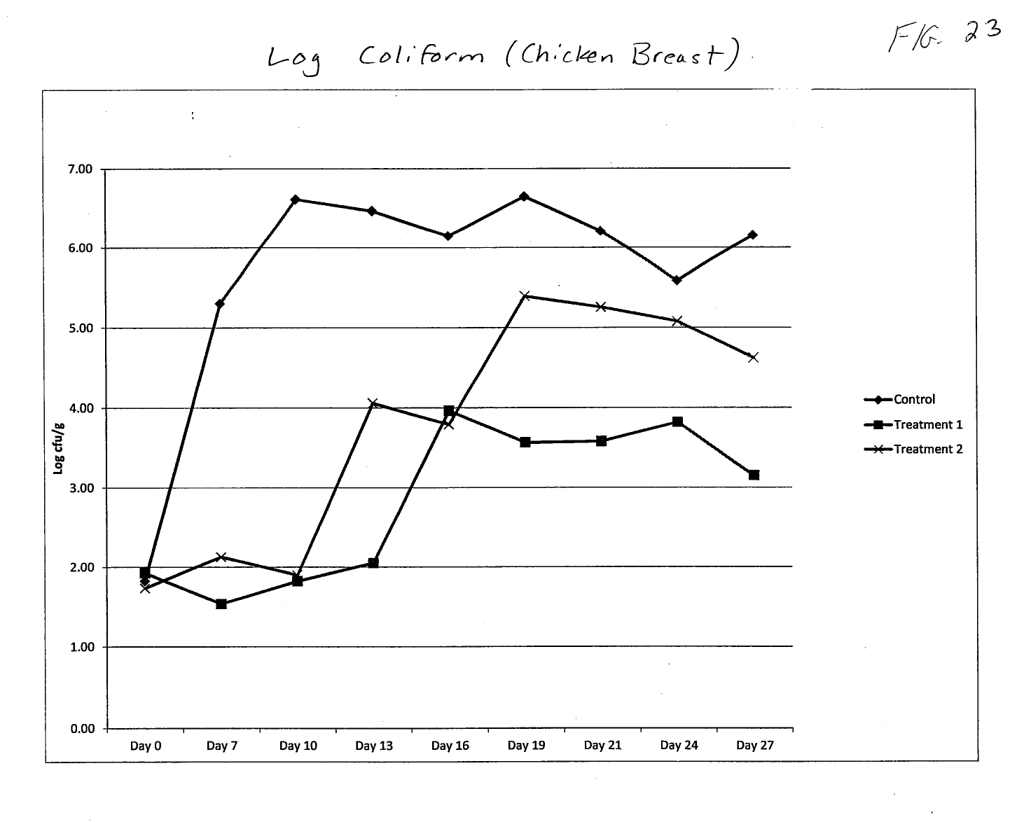

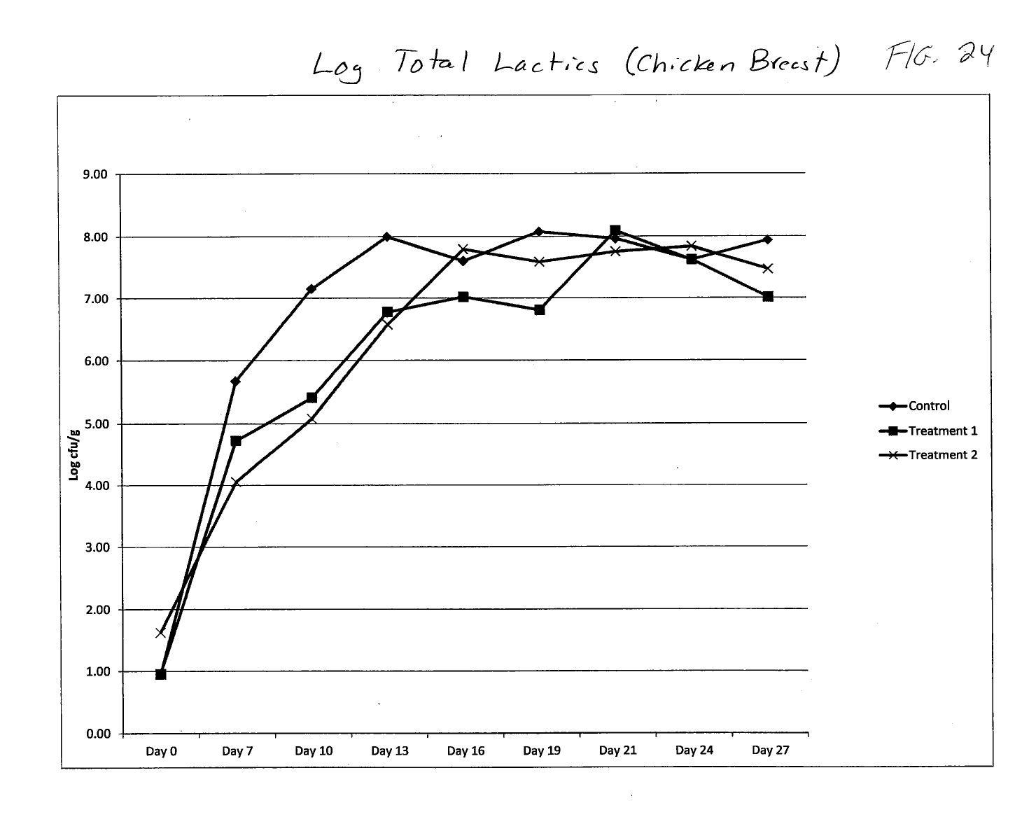

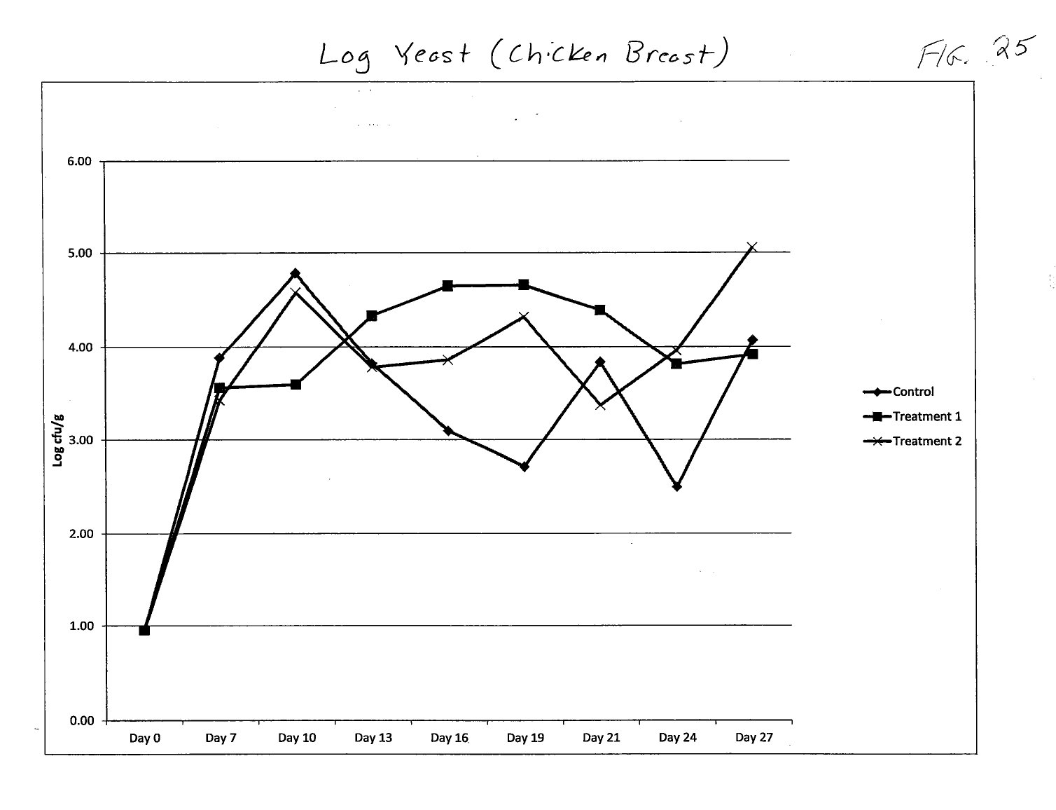

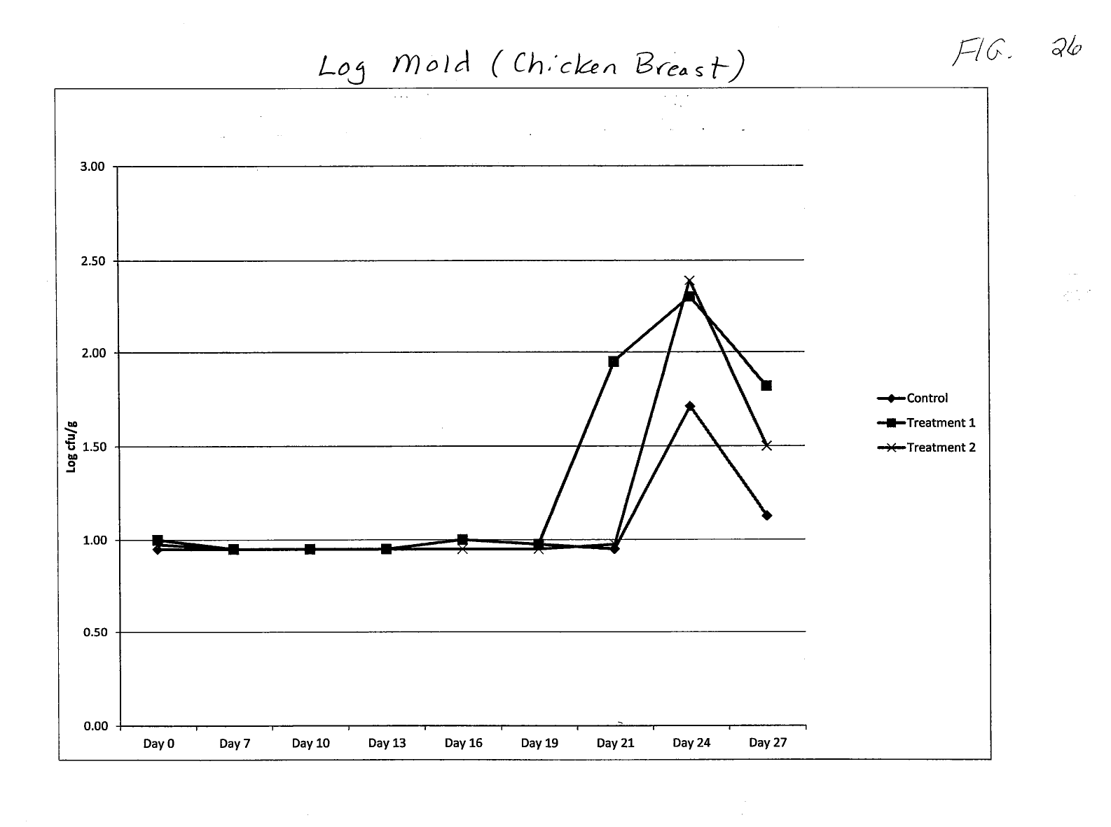

Aerobic plate count, E. coli, coliforms, lactic acid bacteria, yeast, mold, and listeria were monitored and the positive results for the invention are shown in FIGS. 22-26.

### EXAMPLES 5A and 5B (GROUND PORK)

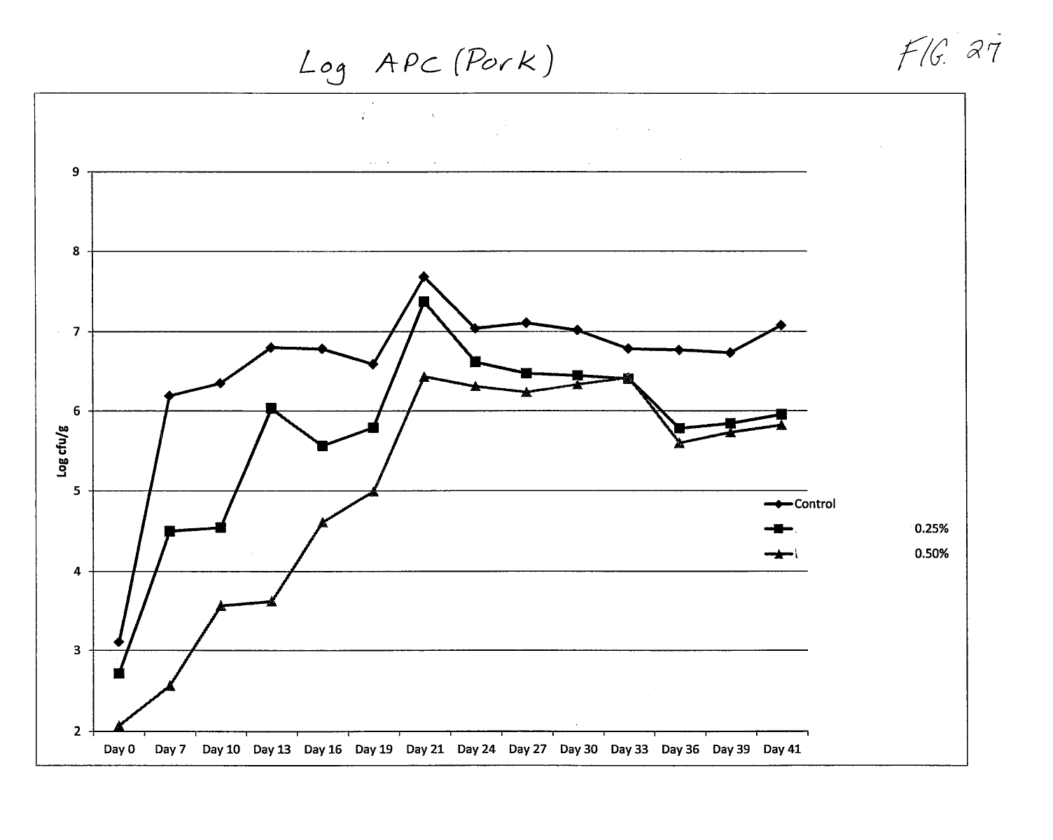

Ground pork was obtained and brined in the composition at 0.25% of Example 1 (Example 5A) and 0.5% of Example 1 (Example 5B) were directly added with untreated ground pork as the control. Aerobic and anaerobic plate counts are shown in FIG. 27.

### EXAMPLES 6A and 6B (GROUND BEEF)

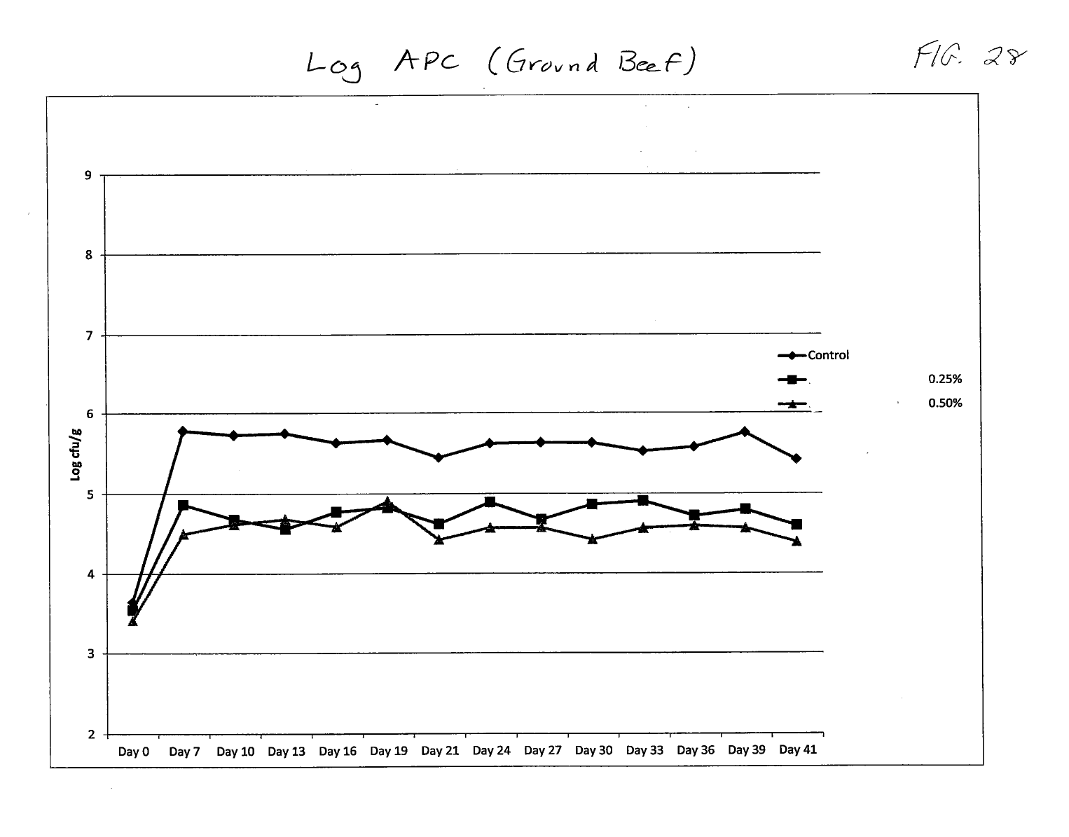

Beef top round was obtained, ground, and treated with the composition at 0.25% of Example 1 (Example 6A) and 0.5% of Example 1 (Example 6B) with untreated ground beef as the control. Aerobic and anaerobic plate counts are shown in FIG. 28.

### EXAMPLES 7 to 10A/10B

The affect of the compositions of another embodiment of the invention on shelf life and antimicrobial properties were tested on ground chicken, ground beef, chicken breast and pork. The compositions used as an additive in Examples 7-10 (“Compositions B and C”) comprise

| Ingredient | % in Composition B | % in Composition C |
|---|---|---|
| Grapefruit Seed Extract | 6.600 | 10.000 |
| Lemon Base Powder | 20.000 | 20.000 |
| Dextrose (Natural) | 1.619 | 1.619 |
| Maltodextrin | 57.800 | 54.400 |
| Flavorant* | 9.881 | 9.881 |
| Silicon Dioxide | 0.600 | 0.600 |
| Propylene Glycol | 0.200 | 0.200 |
| Sodium Carbonate | 3.300 | 3.300 |

*hops, curry, ginger, lovage, fenugreek, chili powder, garlic

### EXAMPLES 7A and 7B (GROUND CHICKEN)

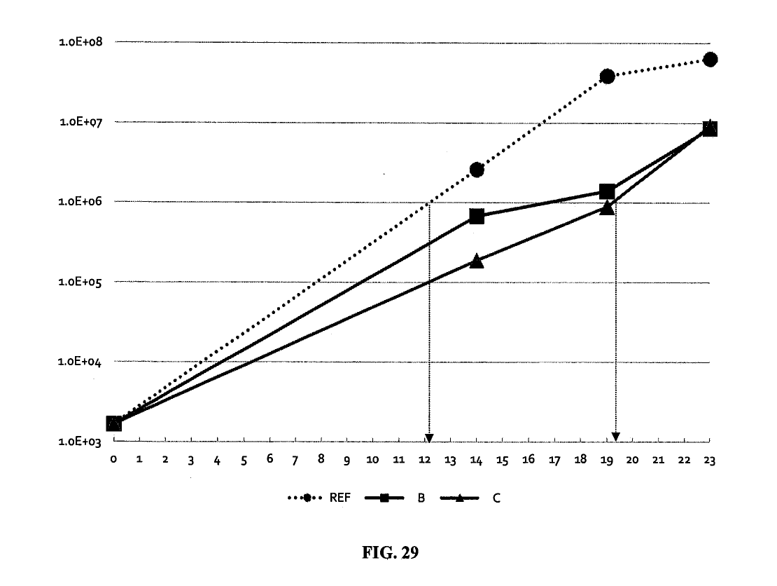

Composition B and Composition C were added to ground chicken with untreated ground chicken as a control (reference). Lactic Acid Bacteria was monitored and the positive results for the inventions are shown in FIG. 29.

### EXAMPLES 8A and 8B (GROUND BEEF)

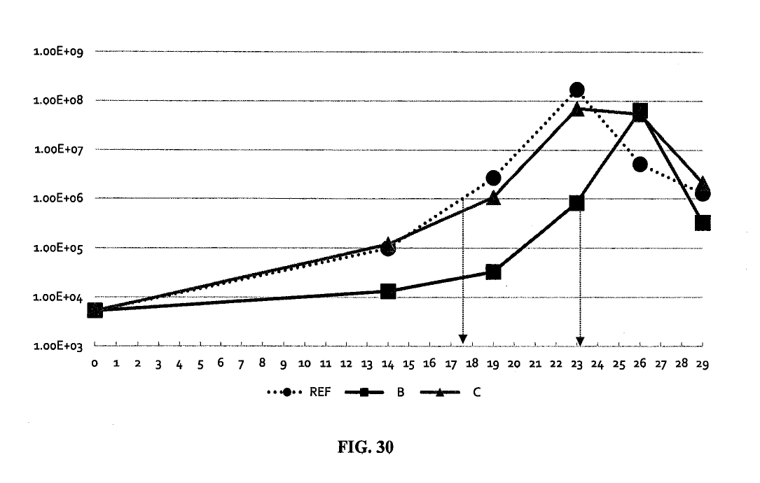

Composition B and Composition C were added to ground beef with untreated ground beef as a control (reference). Lactic Acid Bacteria was monitored and the positive results for the inventions are shown in FIG. 30.

### EXAMPLES 9A and 9B (CHICKEN BREAST)

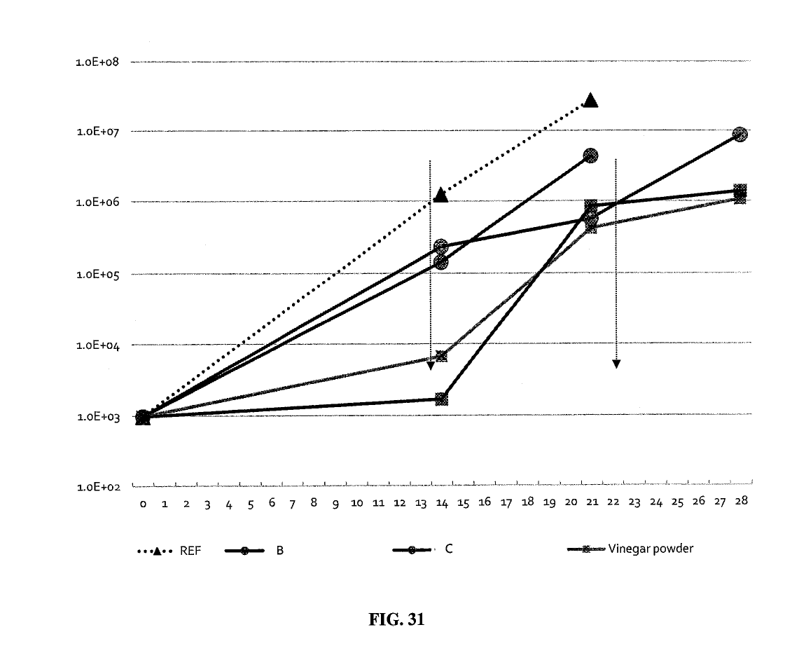

Composition B and Composition C were added to chicken breast with untreated chicken breast as a control (reference) along with vinegar. Lactic Acid Bacteria was monitored and the positive results for the inventions are shown in FIG. 31.

### EXAMPLES 10A and 10B (PORK)

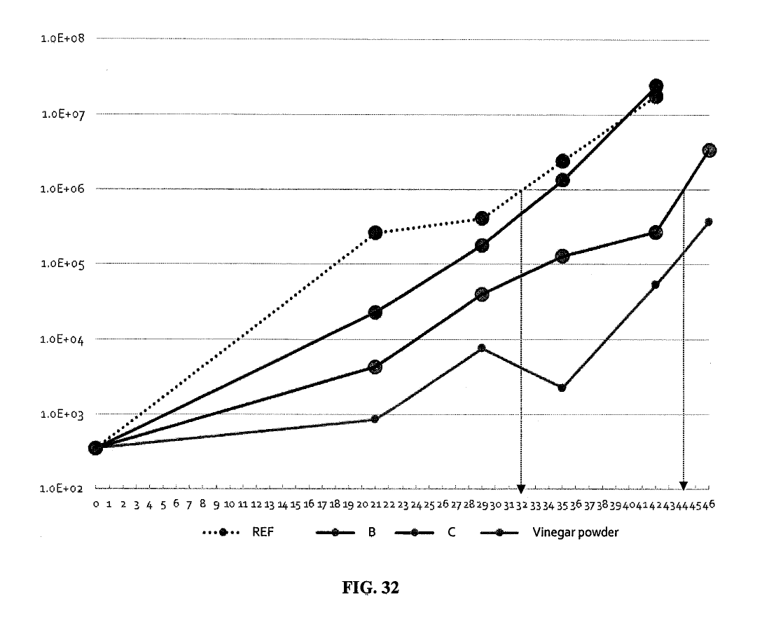

Composition B and Composition C were added to pork with untreated pork as a control (reference) along with vinegar. Lactic Acid Bacteria was monitored and the positive results for the inventions are shown in FIG. 32.

Having thus described certain embodiments of the present invention, it is to be understood that the invention defined by the appended claims is not to be limited by particular details set forth in the above description including the examples as many apparent variations thereof are possible without departing from the spirit or scope thereof as hereinafter claimed.

That which is claimed:

1. A composition for providing antimicrobial properties to food, the composition comprising:
a) 10 to 50% by weight grapefruit and/or grapefruit seed extract;
b) 20 to 50% by weight citrus fruit extract(s); and
c) 5 to 20% by weight of one or more flavorants.

2. The composition of claim 1, wherein the one or more flavorants is selected from the group consisting of cacao, pomegranate, hops, curry, coriander, nutmeg, lovage, fenugreek, olive, onion, garlic, oregano, cinnamon, rosemary, thyme, tarragon, lemon grass, cumin, and anise.

3. The composition of claim 1, further comprising a carrier.

4. The composition of claim 1, wherein the carrier is selected from the group consisting of dextrose, maltodextrin, starch, rice flour and salt, and blends thereof.

5. The composition of claim 1, further comprising 0.05 to 7.0% by weight sodium carbonate.

6. A food product treated with the composition of claim 1.

7. A composition for providing antimicrobial properties to food, the composition comprising:
a) 10 to 50% by weight grapefruit and/or grapefruit seed extract;
b) 20 to 50% by weight of a citrus fruit extract(s) selected from the group consisting of orange extract, lime extract and lemon extract, and blends thereof; and
c) 5 to 20% by weight of cacao and/or pomegranate.

8. The composition of claim 7, further comprising a carrier.

9. The composition of claim 7, wherein the carrier is selected from the group consisting of dextrose, maltodextrin, starch, rice flour and salt, and blends thereof.

10. The composition of claim 7, further comprising 0.05 to 7.0% by weight sodium carbonate.

11. A food product treated with the composition of claim 7.

12. A composition for providing antimicrobial properties to food, the composition comprising:
a) 10 to 90% by weight grapefruit and/or grapefruit seed extract;
b) 10 to 90% by weight lemon extract; and
c) 0 to 20% by weight of one or more flavorants.

13. The composition of claim 12, wherein the one or more flavorants is selected from the group consisting of cacao, pomegranate, hops, curry, coriander, nutmeg, lovage, fenugreek, olive, onion, garlic, oregano, cinnamon, rosemary, thyme, tarragon, lemon grass, cumin, and anise.

14. The composition of claim 12, further comprising a carrier.

15. The composition of claim 12, wherein the carrier is selected from the group consisting of dextrose, maltodextrin, starch, rice flour and salt, and blends thereof.

16. The composition of claim 12, further comprising 0.05 to 7.0% by weight sodium carbonate.

17. The composition of claim 12, wherein the lemon extract is a powder.

18. A food product treated with the composition of claim 12.

19. A food product treated with the composition of claim 17.
